(19) United States
(12) Patent Application Publication
(10) Pub. No.: US 2007/0216224 A1
(43) Pub. Date: Sep. 20, 2007

(54) Method and system for reducing vehicle brake creep noise

(76) Inventors: Otto Schmitt, Grafschaft-Ringen (DE); Mark Bartol, Farmington Hills, MI (US); Gregoire Mercier, Ypsilanti, MI (US)

Correspondence Address: MACMILLAN, SOBANSKI & TODD, LLC, ONE MARITIME PLAZA - FOURTH FLOOR, 720 WATER STREET, TOLEDO, OH, 43604, US

(21) Appl. No.: 11/384,790

(22) Filed: Mar. 20, 2006

(51) Int. Cl. B60T 8/32

(52) U.S. Cl. 303/191; 303/DIG. 1; 303/DIG. 2

(57) ABSTRACT

The invention concerns a method and system for reducing vehicle brake creep noise by adjusting the pressure in selected wheel brake assemblies when the vehicle speed is less than a speed threshold and the brake pressure is less than a pressure threshold.

### BACKGROUND OF INVENTION

The present invention relates generally to a vehicle braking system, and in particular to a vehicle braking system and method of operation that will reduce or eliminate noise from the brakes generated when a vehicle is creeping.

For some automotive vehicles moving at very low speeds with the brakes partially actuated (i.e., with low brake pressures), a noise is generated by the brakes that is known as creep groan. The noise is generated as the pad/lining rubs on the rotor/drum. This creep noise is irritating to some vehicle occupants and so it is desirable to minimize or eliminate the noise.

Since creep groan occurs at very low vehicle speeds with low brake pressures, a change in vehicle speed or a change in brake pressures may alleviate the creep noise problem. Adjusting the vehicle speed is not practical since presumably the driver is intentionally driving at this very low speed. Increasing or decreasing the overall brake pressure would change the vehicle speed—again something that would presumably be unwanted by the vehicle operator.

It is desirable, therefore, to provide a way to minimize or eliminate creep noise, while also allowing a vehicle operator to travel at a desired slow vehicle speed.

### SUMMARY OF INVENTION

An embodiment contemplates a method of reducing creep groan noise emitted from brakes of a vehicle, the method comprising the steps of: determining a vehicle speed; determining a brake pressure; determining if the vehicle speed is less than a speed threshold; determining if the brake pressure is less than a pressure threshold; and adjusting the brake pressure in at least one but less than all of the brakes to thereby reduce the creep groan noise if the vehicle speed is less than the speed threshold and the brake pressure is less than the pressure threshold.

An embodiment contemplates a method of reducing creep groan noise emitted from brakes of a vehicle, the method comprising the steps of: determining a vehicle speed; determining a brake pressure; determining if the vehicle speed is less than a speed threshold and the vehicle is still moving; determining if the brake pressure is less than a pressure threshold; and reducing the brake pressure in at least one but less than all of the brakes and increasing the brake pressure in at least one of the brakes for which the brake pressure was not reduced in order to maintain an overall vehicle braking, if the vehicle speed is less than the speed threshold, the vehicle is still moving and the brake pressure is less than the pressure threshold.

An embodiment contemplates a brake system for a vehicle including a plurality of wheel brakes; a pressure modulator operatively engaging the plurality of wheel brakes and capable of selectively varying a brake pressure between each of the wheel brakes; and a controller in communication with the pressure modulator and controlling the pressure modulator to adjust the brake pressure in at least one but less than all of the wheel brakes if a vehicle speed is less than a speed threshold and the brake pressure is less than a pressure threshold.

An advantage of an embodiment is that the creep groan noise from the brakes is significantly reduced or eliminated, while still allowing a vehicle operator to travel at a desired low speed with the brakes partially actuated.

An advantage of an embodiment is that the creep noise is reduced or eliminated while not requiring the addition of or changes to the hardware of the brake system, thus minimizing the cost to implement this solution to creep noise concerns.

### BRIEF DESCRIPTION OF DRAWINGS

FIG. 1 is a schematic view of a vehicle and its braking system.

FIG. 2 is a flow chart illustrating a method for reducing or eliminating creep groan noise in a vehicle braking system.

### DETAILED DESCRIPTION

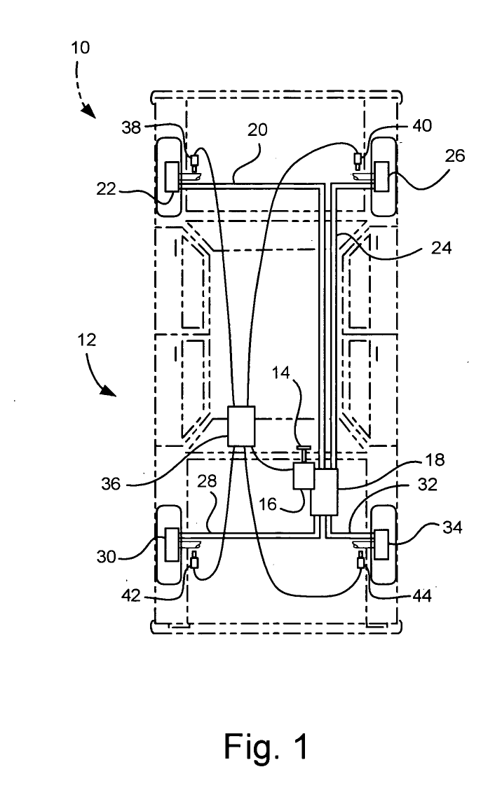

FIG. 1 illustrates a vehicle, indicated generally at 10, having a brake system, indicated generally at 12. The brake system 12 is a type where the brake pressure applied at one or more of the wheel brakes may be selectively different than the brake pressure applied at one or more of the other wheel brakes. Such systems are commonly referred to as slip control, anti-lock braking (ABS), traction control, and/or stability control.

The brake system 12 includes a brake pedal 14 that operatively engages a brake master cylinder 16, with or without a brake booster (not shown) interconnecting the two. The master cylinder 16 operatively engages an electro-hydraulic modulator 18 (also called an ABS actuator or a pressure modulator). The master cylinder 16 and modulator 18 may be two discrete, interconnected components or may be integrated into a single unit, if so desired. The modulator 18 may include solenoid operated valves (not shown) and an electric pump (not shown) for cycling pressure to brake assemblies on each wheel, as is known to those skilled in the art. A first hydraulic line 20 operatively connects the modulator 18 to a right rear wheel brake assembly 22, a second hydraulic line 24 operatively connects the modulator 18 to a left rear wheel brake assembly 26, a third hydraulic line 28 operatively connects the modulator 18 to a front right wheel brake assembly 30, and a fourth hydraulic line 32 operatively connects the modulator 18 to a front left wheel brake assembly 34. The brake assemblies 22, 26, 30, 34 may be disc or drum brakes or a combination of the two.

The master cylinder 16 and/or modulator 18 are in electronic communication with a control module 36, (commonly called an ABS control module or slip control module). The control module 36 is also in electronic communication with a right rear wheel speed sensor assembly 38, a left rear wheel speed sensor assembly 40, a right front wheel speed sensor assembly 42 and a left front wheel speed sensor assembly 44. The speed sensor assemblies 38, 40, 42, 44 may employ magnetic, optic or other suitable types of sensors, and may include sensor rotors (toothed wheels) or other suitable types of rotating means for sensing rotational speed, as is known to those skilled in the art.

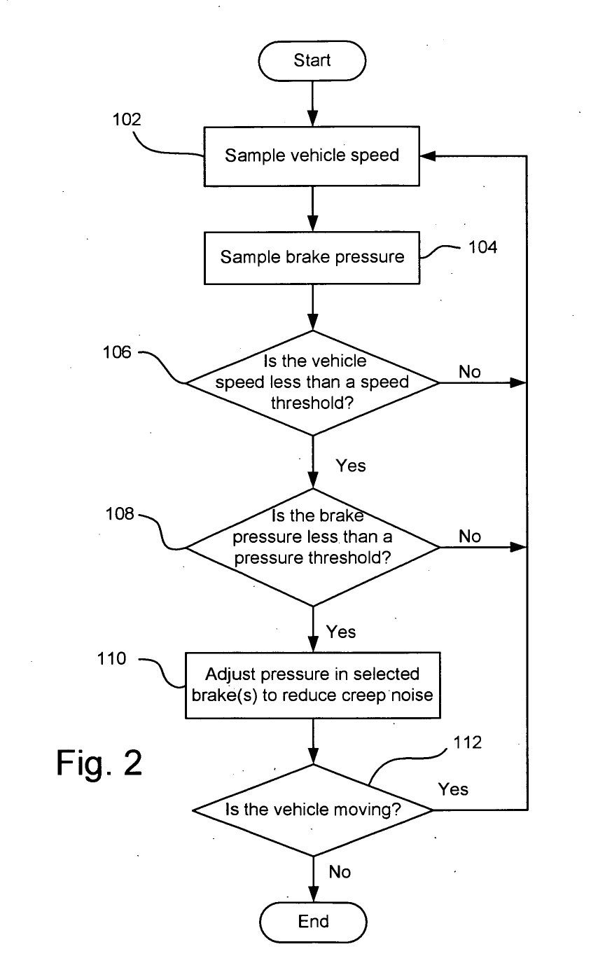

The mechanical, electrical and hydraulic layout and connection of components discussed relative to this brake system 12 are known to those skilled in the art and so will not be discussed or shown in any more detail herein. Also, the brake system 12 disclosed in FIG. 1 is an example of a brake system to which the method of FIG. 2 can be applied. However, it is to be understood that this is just one example, and that the method of FIG. 2 can be applied to other types of brake systems having an ability to cause differing amounts of brake pressure on one or more of the wheel brakes.

FIG. 2 is a flow chart illustrating a method of eliminating creep groan noise that is applicable to a vehicle brake system with slip control, such as, for example, the vehicle brake system 12 illustrated in FIG. 1. This method begins by sampling the speed of the vehicle 10, block 102. This vehicle speed calculation can employ the outputs from the wheel speed sensor assemblies 38, 40, 42, 44 or outputs from some other suitable sensor arrangement, as is known to those skilled in the art. The brake pressure is also sampled, block 104. The brake pressure calculation can employ hydraulic pressures measured in the master cylinder 16, pressure modulator 18, hydraulic lines 20, 24, 28, 32, or use other suitable means to determine the brake pressure, as is known to those skilled in the art. The brake pressure, as used herein, is the brake pad load on a particular wheel brake assembly.

The calculated vehicle speed is compared to a speed threshold, block 106. If the vehicle speed is not less than the speed threshold, then creep groan noise is not a concern, so the routine starts over again. The range of vehicle speed where creep groan typically occurs is, for example, while the vehicle is moving at about eight kilometers/hour or less. Of course, the actual value of the speed threshold may vary depending upon the particular vehicle and brake system. If the vehicle speed is less than the speed threshold, the brake pressure is compared to a pressure threshold, block 108. If the brake pressure is not less than the pressure threshold, then creep groan noise is not a concern, so the routine starts over again. The brake pressure (i.e., brake pad load) range at which creep groan occurs is a relatively low brake pressure that allows the driver to maintain the vehicle speed within the slow vehicle speed range—as opposed to a higher pressure that will cause the vehicle to stop, or a release of brake pressure where the vehicle will accelerate above the very slow speed range. The actual numerical value of the brake pressure threshold will vary depending upon the particular vehicle, engine, and brake system to which this method is applied.

If the brake pressure is less than the pressure threshold, the pressure in selected brakes is adjusted to reduce or eliminate creep groan noise, block 110. The pressure adjustment can be initiated via signals sent from the control module 36 to the pressure modulator 18 that cause the hydraulic pressure in one or more hydraulic lines 20, 24, 28, 32 to change. The change in hydraulic pressure will, of course, change the brake pressure at that particular brake or brakes. The change in brake pressure may be a single step change, or, more preferably, may include multiple fluctuations in pressure. A determination is then made whether the vehicle 10 is still moving, block 112. If it is, then the routine starts over again. If the vehicle 10 is not moving, then the routine ends.

The pressure adjustment in selected brakes, according to block 110, is accomplished by reducing or eliminating the brake pressure applied to one or more (but less than all) of the wheel brakes, which will cause the control module 36 to compensate by increasing the brake pressure applied to one or more of the other wheel brakes in order to maintain the overall total vehicle braking. Alternatively, the pressure adjustment in selected brakes, according to block 110, is accomplished by increasing the brake pressure applied to one or more (but less than all) of the wheel brakes, which will cause the control module 36 to compensate by decreasing the brake pressure applied to one or more of the other wheel brakes in order to maintain the overall total vehicle braking. In deciding which wheel brake or brakes to reduce or eliminate brake pressure (or alternatively increase brake pressure, as the case may be), often times it is known for a particular vehicle which axle has a higher propensity for creep groan. This information, then, can be taken into account when determining which wheel brake(s) will have brake pressure reduced or eliminated (or alternatively, increased) and which other wheel brake(s) will compensate for this by having brake pressure increased (or alternatively, decreased) to maintain the desired overall vehicle braking.

Even though the embodiment disclosed herein has a brake system with four channel ABS. (i.e., the hydraulic pressure to the brake assembly at each vehicle wheel is independently controllable) this method to reduce creep groan noise is also applicable to brake systems with other numbers of channels greater than one. In addition, while the embodiment disclosed herein has a brake system that employs hydraulic fluid as the medium for applying brake pressure, this is also applicable to brake systems with slip control that use pneumatic or electric actuation for applying brake pressure.

While certain embodiments of the present invention have been described in detail, those familiar with the art to which this invention relates will recognize various alternative designs and embodiments for practicing the invention as defined by the following claims.

What is claimed is:

1. A method of reducing creep groan noise emitted from brakes of a vehicle, the method comprising the steps of:
determining a vehicle speed;
determining a brake pressure;
determining if the vehicle speed is less than a speed threshold;
determining if the brake pressure is less than a pressure threshold; and
adjusting the brake pressure in at least one but less than all of the brakes to thereby reduce the creep groan noise if the vehicle speed is less than the speed threshold and the brake pressure is less than the pressure threshold.

2. The method of claim 1 wherein the step of adjusting the brake pressure is further defined by reducing the brake pressure in at least one but less than all of the brakes.

3. The method of claim 2 wherein the step of adjusting the brake pressure is further defined by increasing the brake pressure in at least one of the brakes for which the brake pressure was not reduced in order to maintain an overall vehicle braking.

4. The method of claim 2 further including the steps of: determining if the vehicle is moving, and ceasing the adjustment of brake pressure if the vehicle is not moving.

5. The method of claim 1 further including the steps of: determining if the vehicle is moving, and ceasing the adjustment of brake pressure if the vehicle is not moving.

6. The method of claim 1 wherein the step of adjusting the brake pressure is further defined by increasing the brake pressure in at least one but less than all of the brakes.

7. The method of claim 6 wherein the step of adjusting the brake pressure is further defined by decreasing the brake pressure in at least one of the brakes for which the brake pressure was not increased in order to maintain an overall vehicle braking.

8. The method of claim 6 further including the steps of: determining if the vehicle is moving, and ceasing the adjustment of brake pressure if the vehicle is not moving.

9. The method of claim 1 wherein the step of determining the vehicle speed is further defined by receiving and processing signals from a plurality of wheel speed sensors.

10. The method of claim 1 wherein the step of adjusting the brake pressure is further defined by adjusting hydraulic pressure in more than one of a plurality of hydraulic brake lines.

11. The method of claim 1 wherein the speed threshold is a speed in the range of about eight kilometers/hour to about 0.1 kilometers/hour.

12. The method of claim 11 wherein the step of adjusting the brake pressure is further defined by reducing the brake pressure in at least one but less than all of the brakes and by increasing the brake pressure in at least one of the brakes for which the brake pressure was not reduced in order to maintain an overall vehicle braking.

13. A method of reducing creep groan noise emitted from brakes of a vehicle, the method comprising the steps of:
determining a vehicle speed;
determining a brake pressure;
determining if the vehicle speed is less than a speed threshold and the vehicle is still moving;
determining if the brake pressure is less than a pressure threshold; and
reducing the brake pressure in at least one but less than all of the brakes and increasing the brake pressure in at least one of the brakes for which the brake pressure was not reduced in order to maintain an overall vehicle braking, if the vehicle speed is less than the speed threshold, the vehicle is still moving and the brake pressure is less than the pressure threshold.

14. The method of claim 13 wherein the speed threshold is a speed in the range of about eight kilometers/hour to about 0.1 kilometers/hour.

15. The method of claim 13 wherein the step of adjusting the brake pressure is further defined by adjusting hydraulic pressure in more than one of a plurality of hydraulic brake lines.

16. A brake system for a vehicle comprising:
a plurality of wheel brakes;
a pressure modulator operatively engaging the plurality of wheel brakes and capable of selectively varying a brake pressure between each of the wheel brakes; and
a controller in communication with the pressure modulator and controlling the pressure modulator to adjust the brake pressure in at least one but less than all of the wheel brakes if a vehicle speed is less than a speed threshold and the brake pressure is less than a pressure threshold.

17. The brake system of claim 16 wherein the controller controls the pressure modulator to cease adjusting the brake pressure if the vehicle is not moving.

18. The brake system of claim 16 further including a plurality of hydraulic lines operatively engaging the pressure modulator and the plurality of wheel brakes, and a master cylinder operatively engaging the pressure modulator.

19. The brake system of claim 16 further including a plurality of wheel speed sensors in communication with the controller.

20. The brake system of claim 16 wherein the controller controls the pressure modulator to adjust the brake pressure in at least one but less than all of the wheel brakes by increasing the brake pressure in at least one but less than all of the wheel brakes and by decreasing the brake pressure in at least one of the wheel brakes for which the brake pressure was not increased in order to maintain an overall vehicle braking.
